(19) United States
(12) Patent Application Publication
(10) Pub. No.: US 2025/0338060 A1
(43) Pub. Date: Oct. 30, 2025

(54) SPEAKER APPARATUS

(71) Applicant: SAMSUNG ELECTRONICS CO., LTD., Suwon-si (KR)

(72) Inventors: Liam KELLY, Suwon-si (KR); Jongbae KIM, Suwon-si (KR); Hoseok WEY, Suwon-si (KR); Sungjoo KIM, Suwon-si (KR); Dongkyu PARK, Suwon-si (KR)

(73) Assignee: SAMSUNG ELECTRONICS CO., LTD., Suwon-si (KR)

(21) Appl. No.: 19/068,527

(22) Filed: Mar. 3, 2025

Related U.S. Application Data
(63) Continuation of application No. PCT/KR2025/001648, filed on Feb. 4, 2025.

(30) Foreign Application Priority Data
Apr. 25, 2024 (KR) 10-2024-0055359

(51) Int. Cl. H04R 1/28; H04R 1/02

(52) U.S. Cl. CPC H04R 1/2857; H04R 1/025; H04R 1/288

(57) ABSTRACT

A speaker apparatus may include a housing; a transducer inside the housing and configured to generate sound waves; and an acoustic structure inside the housing and including a plurality of resonant passages, each resonant passage of the plurality of resonant passages having an opening facing toward the transducer so that the sound waves enter the opening and travel along the resonant passage.

### CROSS-REFERENCE TO RELATED APPLICATIONS

This application is a by-pass continuation application of International Application No. PCT/KR2025/001648, filed on Feb. 4, 2025, which is based on and claims priority to Korean Patent Application No. 10-2024-0055359, filed on Apr. 25, 2024, in the Korean Intellectual Property Office, the disclosures of which are incorporated by reference herein in their entireties.

### BACKGROUND

### 1. Field

The present disclosure relates to a speaker apparatus.

### 2. Description of Related Art

A speaker apparatus is an apparatus that converts electrical signals into sound waves and radiates them. Generally, a speaker apparatus includes a box-shaped enclosure with an empty space inside and a transducer that generates sound waves by the vibration of a diaphragm. The transducer may convert electrical signals into sound waves, and may produce sound waves of various sound ranges from low frequency to high frequency.

A speaker apparatus may be combined and used with various electronic devices such as TVs, monitors, refrigerators, etc., and as the size of electronic devices has become slimmer due to technological advancements, the size of the speaker apparatus that is attached thereto also needs to be reduced. In response to this need, a slot loading loudspeaker (SLL) with a thinly designed sound radiation opening was devised.

The slot loading loudspeaker is characterized by a structure in which a transducer is embedded within an enclosure. However, the problem with the slot loading loudspeaker is that the sound waves that are reflected inside the enclosure and then radiated are mutually reinforced and/or offset by the sound waves that are radiated to the outside from the transducer without going through a reflection process, and thus the amplitude spectrum characteristics of the sound waves are distorted in an uneven form, resulting in a deterioration of the overall sound quality.

Accordingly, prior art technologies of adjusting the frequency of sound waves using a separate device such as a parametric equalizer (PEQ) have been used, but such technologies have the problem of large consumption of electric energy applied to the speaker apparatus and excessive load at the computational resource level.

### SUMMARY

In accordance with the present disclosure, a speaker apparatus may include a housing; a transducer inside the housing and configured to generate sound waves; and an acoustic structure inside the housing and including a plurality of resonant passages, each resonant passage of the plurality of resonant passages having an opening facing toward the transducer so that the sound waves enter the opening and travel along the resonant passage.

The housing may include a first housing including an accommodating space in which the transducer and the acoustic structure are accommodated, and a second housing covering one side of the first housing and including a slot facing the transducer to connect the accommodating space to outside of the housing.

At least one resonant passage of the plurality of resonant passages may include a bent portion.

The first housing may include: an accommodating portion in the accommodating space and that is recessed from the one side toward a lower surface of the first housing, and the acoustic structure may include: a first acoustic structure in the accommodating portion, and a second acoustic structure coupled to an inner surface of the second housing and in the accommodating portion.

The second acoustic structure may include a protrusion that protrudes from the inner surface of the second housing toward the first housing.

The speaker apparatus may include: a buffer section between the transducer and the opening of each resonant passage of the plurality of resonant passages.

The speaker apparatus may include: an auxiliary sound absorbing material in the buffer section.

The buffer section may include a portion having a semicircular shape or a rectangular shape.

The acoustic structure may be an acoustic meta-material (AMM).

The housing may include: a first housing, and a second housing coupled to the first housing, and the transducer may be on an inner surface of the first housing, and each resonant passage of the plurality of resonant passages may extend along the inner surface of the first housing in a direction away from the transducer and includes a meander shape having a plurality of bent portions.

### BRIEF DESCRIPTION OF THE DRAWINGS

FIG. 1 is a view provided to explain a slot loading loudspeaker according to the prior art;

FIG. 2 is a perspective view of a speaker apparatus according to an embodiment;

FIG. 3 is an exploded view of a speaker apparatus according to an embodiment;

FIG. 4 is a view provided to explain a resonant passage according to an embodiment;

FIG. 5 is a view provided to explain an auxiliary sound absorbing material according to an embodiment;

FIG. 6 is a graph for comparing sound waves of sound radiating outwardly from a speaker apparatus according to the prior art and embodiments of the present disclosure;

FIG. 7 is an exploded view of a speaker apparatus according to another embodiment;

FIG. 8 is an exploded view of a speaker apparatus according to yet another embodiment;

FIG. 9 is a graph for comparing sound waves of sound radiating outwardly from a speaker apparatus according to FIGS. 7 and 8;

FIG. 10 is an exploded view of a speaker apparatus having a resonant passage of a double-layer structure;

FIG. 11 is a view illustrating a cross-section along line D-D′ of FIG. 10; and

FIG. 12 is a graph provided to explain sound waves of sound radiating outwardly from a speaker apparatus according to FIG. 10.

### DETAILED DESCRIPTION

The various embodiments of the present disclosure and the terms used herein are not intended to limit the technical features described in the present disclosure to specific embodiments, and should be understood to include various changes, equivalents, or replacements of the embodiments.

In connection with the description of the drawings, similar reference numerals may be used for similar or related components.

The singular form of a noun corresponding to an item may include a single item or a plurality of items, unless the relevant context clearly indicates otherwise.

In the present disclosure, “A or B”, “at least one of A and B”, “at least one of A or B”, “A, B or C”, “at least one of A, B and C”, and “at least one of A, B, or C” may include any one of the items listed together in the corresponding phrase, or any possible combination thereof.

The term “and/or” includes a combination of a plurality of related components described herein or any component of a plurality of related components described herein.

Terms such as “first”, “second”, “1st”, or “2nd” may be used simply to distinguish one component from another, and do not limit the corresponding components in other aspects (e.g., importance or order).

When one component (e.g., first) is said to be “coupled” or “connected” to another component (e.g., second) with or without the term of “functionally” or “communicatively”, it means that one component can be connected to another component directly (e.g., via cable), wirelessly, or through a third component.

Terms such as “include” or “have” are intended to indicate the presence of features, numbers, steps, operations, components, parts, or combinations thereof described in this disclosure, but are not intended to preclude the possibility of the presence or addition of one or more other features, numbers, or steps, operations, components, parts, or combinations thereof.

When a component is said to be “connected,” “coupled,” “supported,” or “in contact” with another component, this means not only the case where the components are directly connected, coupled, supported, or in contact, but also the case where they are indirectly connected, coupled, supported, or in contact through a third component.

When a component is said to be located “on” another component, this includes not only the where a component is in contact with another component, but also the case where another component exists between the two components.

Hereinafter, a speaker apparatus according to various embodiments will be described with reference to the accompanying drawings.

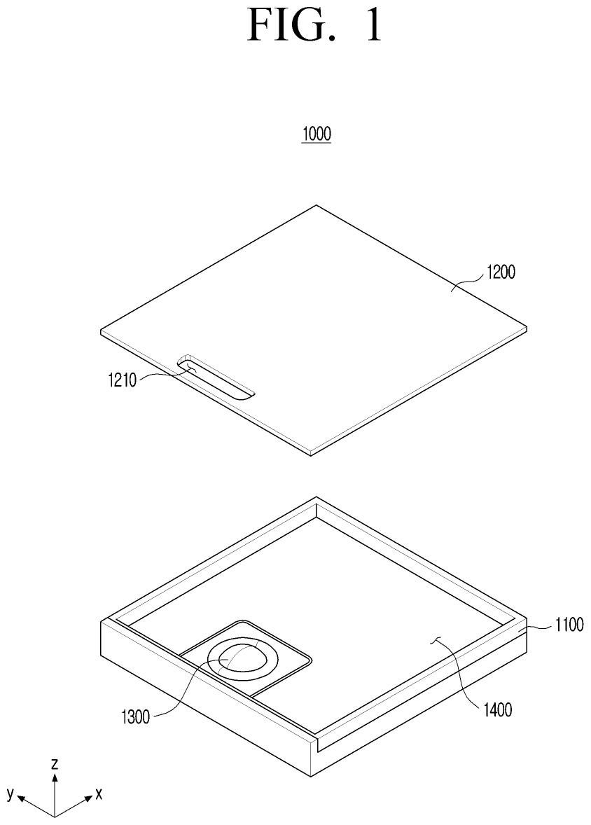

FIG. 1 is a view provided to explain a slot loading loudspeaker according to the prior art. Referring to FIG. 1, a speaker apparatus 1000 according to the prior art may include a housing 1100, a cover 1200, a transducer 1300, and an enclosure 1400.

The housing 1100 may be combined with the cover 1200 to form an enclosure 1400 therein. The enclosure 1400 refers to a portion of the accommodating space combining the housing 1100 and the cover 1200 excluding the space occupied by the transducer 1300.

The transducer 1300 is a component that generates sound by converting an applied electrical signal into sound waves, and depending on the frequency range of the sound waves generated, various types such as tweeters, woofers, midrange speakers may be used.

The cover 1200 may include a slot 1210 for radiating sound waves generated from the transducer 1300 to the outside. The slot 1210 may be an opening to connect the exterior and interior of the speaker apparatus 1000. The shape of the slot 1210 may vary, and is not limited to a rectangular shape as shown in the drawing.

The enclosure 1400 refers to a space formed by combining the housing 1100 and the cover 1200. The enclosure 1400 may be formed as a very thin space to allow the speaker apparatus 1000 to be installed in a small space.

The enclosure 1400 may be provided with the transducer 1300, and sound waves generated from the transducer 1300 may be radiated to the outside of the speaker apparatus 1000 through the slot 1210.

As sound waves that have undergone constructive and destructive interference within the enclosure 1400 are emitted through the slot 1210, additional constructive interference may occur with the sound waves directly emitted from the transducer 1300 to the outside of the speaker apparatus 1000.

As such, in the prior art slot loading loudspeaker apparatus 1000, since the transducer 1300 is provided inside the housing 1100, i.e., within the enclosure 1400, there is an issue where sound waves emitted by the transducer 1300 could reflect off the inner surfaces of the housing 1100 and the cover 1200 within the enclosure 1400, and after that, during the process of being emitted to the outside of the loudspeaker device 1000, various frequency components within the sound wave could cause destructive or constructive interference, leading to a degradation in sound quality.

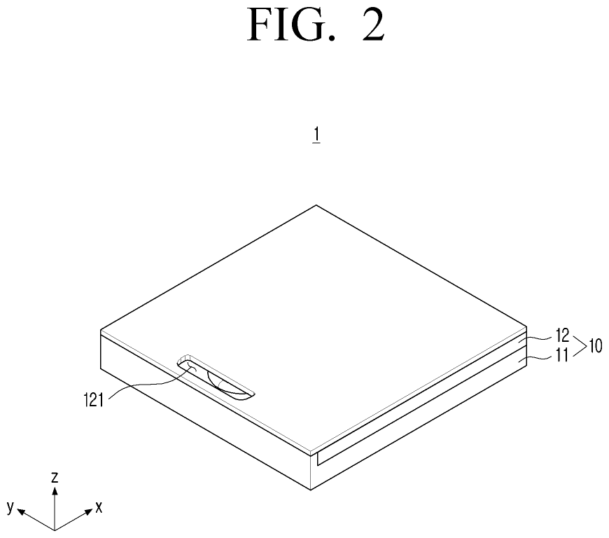

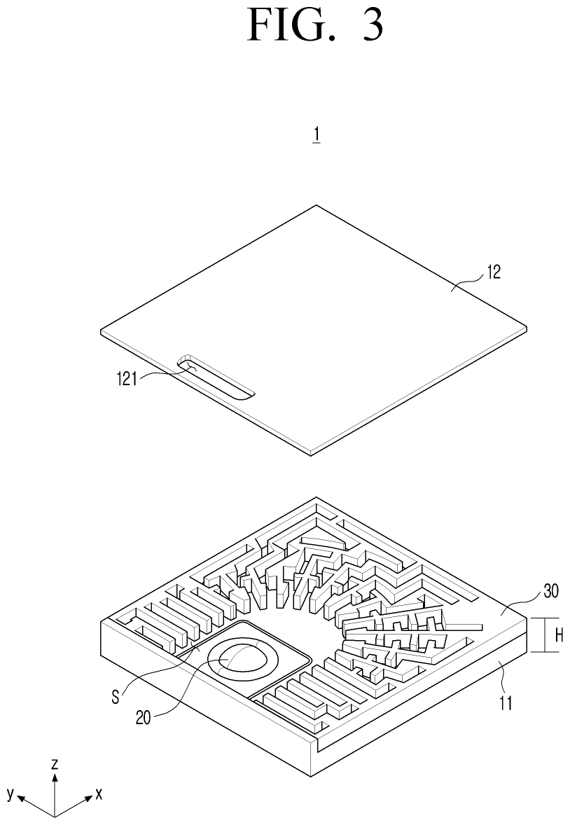

FIG. 2 is a perspective view of a speaker apparatus according to an embodiment. FIG. 3 is an exploded view of a speaker apparatus according to an embodiment. Referring to FIGS. 2 and 3, a speaker apparatus 1 includes a housing 10, a transducer 20, an acoustic structure 30, and a buffer section 40.

The housing 10 forms the exterior of the speaker apparatus 1 and has a configuration in which an accommodating space S is provided so that other configurations can be arranged therein. The housing 10 may include a first housing 11 and a second housing 12.

The first housing 11 is configured to support the transducer 20 and the acoustic structure 30.

The second housing 12 may have a shape corresponding to the first housing 11 and may be arranged to cover one side of the first housing 11.

In other words, the first housing 11 and the second housing 12 may be formed to have the shape of a hollow hexahedral box as they are combined while being positioned oppositely with corresponding shapes.

The second housing 12 may serve as a cover for the first housing 11. In other words, the first housing 11 may form five sides of the accommodating space S that may contain other configurations therein, and the second housing 12 may form one side of the accommodating space S.

The slot 121 may be formed on one side of the second housing 12. The transducer 20 may be arranged on the lower side of the slot 121.

Although it is described in the embodiments of the present disclosure that the housing 10 is divided into the first housing 11 and the second housing 12, the housing 10 may be manufactured and assembled as the first housing 11 and the second housing 12 separately, or may also be formed in a state in which the first housing 11 and the second housing 12 are combined.

Meanwhile, although not shown in the drawing, when the housing 10 is configured with the first housing 11 and the second housing 12 provided separately and then combined together, a speaker apparatus 1 may include components such as a gasket to ensure that the area where the first housing 11 and the second housing 12 are combined is acoustically sealed. Accordingly, the internal space of the housing 10 can be hermetically sealed.

The slot 121 may be an opening that connects the exterior and interior of the housing 10. The slot 121 may be formed in an area of the second housing 12 that faces the transducer 20.

The shape and opening direction of the slot 121 may vary, and is not limited to those shown in the drawing. However, the slot 121 may be an opening having a cross-sectional area sufficient to allow sound waves generated from the transducer 20 to be transmitted to the outside of the speaker apparatus 1.

The transducer 20 is configured to convert an electrical signal into sound waves, as described in FIG. 1. A portion of the sound waves generated from the transducer 20 may be transmitted to the outside of the speaker apparatus 1 through the slot 121 provided on the upper side of the transducer 20.

The transducer 20 may be arranged in the internal accommodating space S of the housing 10 so as to correspond to the slot 121.

The number of transducers 20 and slot 121 is not limited to a single number, and a plurality of transducers 20 and slot 121 may be provided as needed. However, in the present disclosure, embodiments in which there is one transducer 20 and one slot 121 will be described.

Meanwhile, the height H of the first housing 11 may be 50 mm, but is not limited thereto. As such, the speaker apparatus 1 according to an embodiment may be provided in a slim shape since the first housing 11 has a small height H. Thus, the speaker apparatus 1 according to an embodiment may be used by being combined or arranged in various electronic devices having a small thickness.

The acoustic structure 30 is configured to absorb some of the sound waves generated from the transducer 20. The acoustic structure 30 may be described as an acoustic treatment material, a third housing, etc., but in this disclosure, it will be described as an acoustic structure. The acoustic structure 30 may be provided on the inner surface of the second housing 12 and in the accommodating space S of the first housing 11.

The acoustic structure 30 provided on the inner surface of the second housing 12 may be arranged to cover the entire area corresponding to the inner surface of the second housing 12.

The acoustic structure 30 provided in the accommodating space S may be arranged to face at least one side of the transducer 20. Accordingly, the sound waves generated from the transducer 20 that are not immediately radiated to the outside of the speaker apparatus 1 after generation through the slot 121 may move toward the acoustic structure 30.

The acoustic structure 30 may be an acoustic meta-material (AMM) structure.

The AMM is also referred to as an acoustic meta-material, and may have an assembled form of several elements made of composite materials such as metal or plastic.

Depending on the configuration, the AMM may acoustically realize various types of functions. In particular, the present disclosure focuses on the function of controlling the characteristics of the acoustic amplitude spectrum using the resonance phenomenon. In the case of an AMM designed for this purpose, a plurality of resonant passages 31 may be arranged and controlled to achieve the intended function. Specifically, the shape of the resonant passages 31 is related to the resonance frequencies to be controlled, and the sound having the corresponding frequency can be efficiently absorbed by the AMM. As such, the shape of the resonant passages 31 is not limited to a simple shape such as a straight line or a monotonous curve. A more detailed description of the resonant passages 31 will be provided later.

The composite materials constituting the AMM may be designed to have a repeating pattern that is smaller in size than the wavelength of the sound wave. Accordingly, the frequency of the sound waves to be absorbed may be specified in the process of designing and manufacturing the AMM.

The acoustic structure 30 described in this disclosure has no limitation on the sound waves to be absorbed, and may be manufactured by considering a specific frequency range during the manufacturing process of the speaker apparatus 1.

The acoustic structure 30 may be provided in an area other than the area where the transducer 20 is placed in the accommodating space S. As such, by filling a portion of the accommodating space S, which is an empty space inside the housing 10, the acoustic structure 30 may prevent the sound quality of the sound generated from the speaker apparatus 1 from being deteriorated as the sound waves generated from the transducer 20 and moving inside the accommodating space S are randomly reflected and radiated through the slot 121.

The acoustic structure 30 may include the resonant passages 31. The resonant passages 31 are configured to provide a path through which sound waves generated and transmitted from the transducer 20 can travel.

The sound waves that are generated from the transducer 20 and are not immediately radiated to the outside of the speaker apparatus 1 through the slot 121 may enter the resonant passages 31.

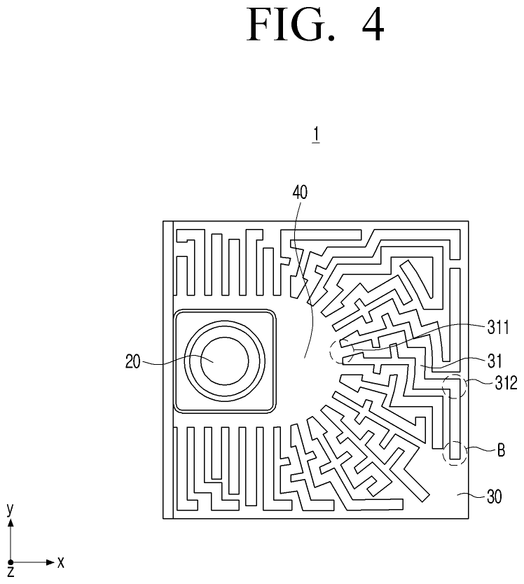

A more specific and detailed description of the resonant passages 31 will be provided later with reference to FIG. 4.

FIG. 4 is a view provided to explain a resonant passage according to an embodiment.

Referring to FIG. 4, a buffer section 40 and resonant passages 31 may be formed inside the speaker apparatus 1.

The buffer section 40 is configured to increase the number of resonant passages 31 into which sound waves generated from the transducer 20 can enter. The buffer section 40 may also be referred to as an “auxiliary cavity portion”.

The buffer section 40 may be an empty space formed between the plurality of resonant passages 31 and the transducer 20.

Accordingly, a greater number of resonant passages 31 may be formed than when the transducer 20 and the openings 311 of the plurality of resonant passages 31 are directly adjacent. One area of the buffer section 40 may be formed in a semicircular or rectangular shape.

When one area of the buffer section 40 is formed in a semicircle shape, the buffer section 40 may be a portion of a circle having a diameter greater than the diameter of the transducer 20. Since the length of the circumference is proportional to the diameter of the circle, a greater number of resonant passages 31 may be arranged when the resonant passages 31 are arranged along the circumference of the semicircular buffer section 40 than when they are arranged along the outer circumference of the transducer 20.

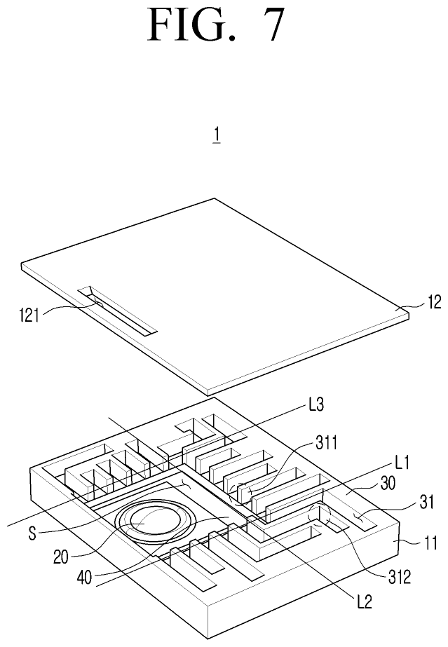

The shape of the one area of the buffer section 40 is not limited to a semicircular shape, and may be formed in a rectangular shape depending on the embodiment. The buffer section 40 including one area of a rectangular shape will be described later with reference to FIG. 7.

The resonant passages 31 are configured to absorb sound waves in a particular frequency range among the sound waves generated from the transducer 20.

The resonant passages 31 may be arranged on the inner surface of the first housing 11. In other words, the resonant passages 31 may be arranged in the accommodating space S.

The resonant passages 31 may have openings 311 formed toward the transducer 20 to allow sound waves generated from the transducer 20 to enter.

The resonant passages 31 may be formed in a meander shape along the inner surface of the first housing 11 in a direction away from the transducer 20 while the openings 311 face the transducer 20. Here, the meander shape may be a structure formed to have a plurality of bending portions. Alternatively, the meander shape may be described as a zigzag shape or a bent pattern, but in the present disclosure, it is described as a meander shape. The meander-shaped resonant passages 31 may be formed by a number of protrusions protruding inward from the inner wall of the resonant passages 31.

The opposite side of the area in which the openings 311 of the resonant passages 31 are formed may have an area B that is closed by the acoustic structure 30.

Accordingly, the sound waves generated from the transducer 20 may enter the openings 311 of the resonant passages 31, be reflected on the surface of the acoustic structure 30, and move toward the closed area B. Subsequently, the sound waves may form standing waves by causing interference with subsequent sound waves that are reflected from the closed area B and enter the inside of the resonant passages 31 through the openings 311. Such standing waves may cause reinforcement and offset interference, resulting in vibration at a specific resonance frequency. This results in the accumulation of acoustic energy of a specific frequency within the resonant passages 31, thereby increasing the degree of acoustic absorption and/or attenuation.

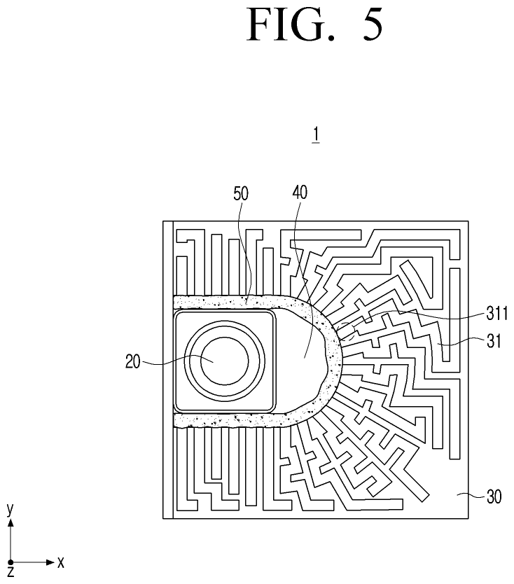

In this case, when an auxiliary sound absorbing material 50 (see FIG. 5) is provided adjacent to the openings 311 of the resonant passages 31, it may help to attenuate the standing waves within the resonant passages 31 and accordingly, the effect of widening the bandwidth of the sound being absorbed can be obtained. A more detailed description of the auxiliary sound absorbing material 50 will be described later with reference to FIG. 5.

In other words, sound waves of a specific frequency that enters the resonant passages 31 through the openings 311 may move to the closed area B of the resonant passages 31 after being reflected at least once inside the resonant passages 31, and standing waves can be formed in this process. In this process, the corresponding sound waves may be absorbed by the acoustic structure 30 or attenuated to a low amplitude without being radiated to the outside of the speaker apparatus 1.

Accordingly, it is possible to prevent deterioration of sound quality caused by interference between sound waves generated from the transducer 20 and directly radiated to the outside of the speaker apparatus 1 and sound waves reflected inside the speaker apparatus 1 and then radiated to the outside.

Meanwhile, the resonant passages 31 may include at least one resonant passage 31 having a bending portion 312.

In the process of designing the resonant passages 31, the specific shape of the resonant passages 31, such as length and width, may be determined based on the resonant frequency to be controlled. The resonant passages 31 whose length is determined in the above process may include at least one bending portion 312 to be accommodated in a limited installation space, i.e., the inside of the housing 10.

The bending portion 312 may be formed such that a specific area of the resonant passages 31 has a shape that is bent at a specific angle.

When designing the resonant passages 31, the size of the passages may be determined analytically based on the frequency of the sound waves to be attenuated. Through this process, the resonant passages 31 whose physical length is determined may be designed in a bent shape at least once in order to save the installation space.

In other words, the resonant passages 31 having the bending portion 312 can increase the total length of the passages through which sound waves can travel by being bent at least once by the bending portion 312 compared to the resonant passages 31 not having the bending portion 312.

The bending portion 312 may be bent at a right angle, but is not limited thereto. For example, the bending portion 312 may have a round shape with a curved surface and may be bent at an angle other than a right angle.

The shape of the bending portion 312 may correspond to a frequency component of the sound waves to be controlled.

In other words, the shape of the bending portion 312 may be designed to attenuate the amplitude of sound waves having frequencies that exhibit a peak and/or dip-shaped spectrum, so as to prevent occurrence of excessive peak and/or dip-shaped characteristics in the amplitude spectrum of sound waves radiated by the speaker 1.

In order to prevent occurrence of a large peak & dip amplitude spectrum due to interference between sound waves radiated after being reflected inside the speaker 1 and sound waves radiated directly to the outside of the speaker 1 from the transducer 20 without going through reflection, the resonant passages 31 may be designed to have a resonance frequency corresponding to a specific frequency component. The shape of the entrance of the resonant passages 31 may be determined acoustically according to the frequency of the sound waves to be controlled and accordingly, it can be designed to have different lengths.

For example, in the case of the resonant passages 31 for absorbing sound waves having a first frequency that is a high frequency among the sound waves generated from the transducer 20, when designing the resonant passages 31, it may be formed longer than the resonant passages 31 for absorbing sound waves having second and third frequencies having lower frequencies.

Here, the first, second, and third frequencies are intended to refer to sound waves of different frequencies, and the expressions first, second, and third do not imply any order or magnitude.

As such, the resonant passages 31 for absorbing sound waves of a specific frequency are formed to have different lengths from the resonant passages 31 for absorbing sound waves of other frequencies, so that each resonant passage 31 can effectively absorb sound waves of a specific frequency to be absorbed.

As such, the shape of the resonant passages 31 may vary depending on the frequency of the sound waves to be absorbed, and even for sound waves of the same frequency, it may vary depending on the overall shape of the speaker apparatus 1.

Further, in the process of manufacturing the speaker apparatus 1, the shape of the resonant passages 31 may be determined by running a simulation using a computer program or the like, and then reflecting the data corresponding to the resulting value.

The resonant passages 31 may be formed by engraving the acoustic structure 30. Specifically, the resonant passages 31 may be formed by engraving the acoustic structure 30 arranged in the accommodating space S of the first housing 11. The upper area of the resonant passages 31 may be covered by the acoustic structure 30 provided in the second housing 12.

As described in FIG. 2, the second housing 12 may be combined to cover one side of the first housing 11, so that when the first housing 11 and the second housing 12 are combined, the resonant passages 31 may be the acoustic structure 30 on all sides except the openings 311.

As such, since the resonant passages 31 have a sealed internal space, when sound waves of a specific frequency to be controlled enter the resonant passages 31 through the openings 311, they can be effectively absorbed by standing waves and resonance phenomena formed within the resonant passages 31.

The openings 311 of the resonant passages 31 may be arranged corresponding to the shape of the buffer section 40. For example, when one area of the buffer section 40 is formed to have a semicircular shape as shown in FIG. 4, the openings 311 of the plurality of resonant passages 31 can be arranged radially along the boundary between the semicircular buffer section 40 and the resonant passages 31.

Thus, in an embodiment where one area of the buffer section 40 is formed in a rectangular shape, the openings 311 of the resonant passages 31 may be arranged in a row according thereto.

A detailed description of the relationship between the resonant passages 31 and the buffer section 40 is as described in FIG. 3, so any redundant description will omitted.

FIG. 5 is a view provided to explain an auxiliary sound absorbing material according to an embodiment. Referring to FIG. 5, the speaker apparatus 1 may further include an auxiliary sound absorbing material 50.

The auxiliary sound absorbing material 50 is configured to allow the sound absorption effect achieved by the resonant passages 31 to be more even and over a wider bandwidth of frequencies. In other words, the auxiliary sound absorbing material 50 may help to flatten the overall amplitude spectrum of the sound waves of sound generated by the speaker 1.

The auxiliary sound absorbing material 50 may act as a damper for the resonant passages 31 as the standing waves formed in the resonant passages 31 transfers some of the acoustic energy of its resonant frequency to sound waves of surrounding frequencies, thereby providing a sound absorbing effect for band components around the resonant frequency. Accordingly, sound absorption for a wider bandwidth can be achieved compared to the sound absorption effect for a single frequency component that can be obtained with only a single resonant passage 31.

The auxiliary sound absorbing material 50 may be arranged in one area of the buffer section 40, and may be formed to have a shape corresponding to one area of the buffer section 40. The auxiliary sound absorbing material 50 may be arranged between the transducer 20 and the resonant passages 31.

Specifically, the auxiliary sound absorbing material 50 may be provided to have a shape that corresponds to a boundary of the buffer section 40 and the openings 311 of the plurality of resonant passages 31. For example, when the buffer section 40 has a semicircular shape as shown in the drawing, the auxiliary sound absorbing material 50 may be formed in an arc shape.

The auxiliary sound absorbing material 50 may be made of a material capable of absorbing vibrations such as sound waves, and may be made of a continuous foam material such as felt, paper or wire mesh, or a multifiber filler, for example.

The speaker apparatus 1 according to an embodiment that includes the auxiliary sound absorbing material 50 may have higher sound absorption performance than the speaker apparatus 1 according to an embodiment that does not include the auxiliary sound absorbing material 50.

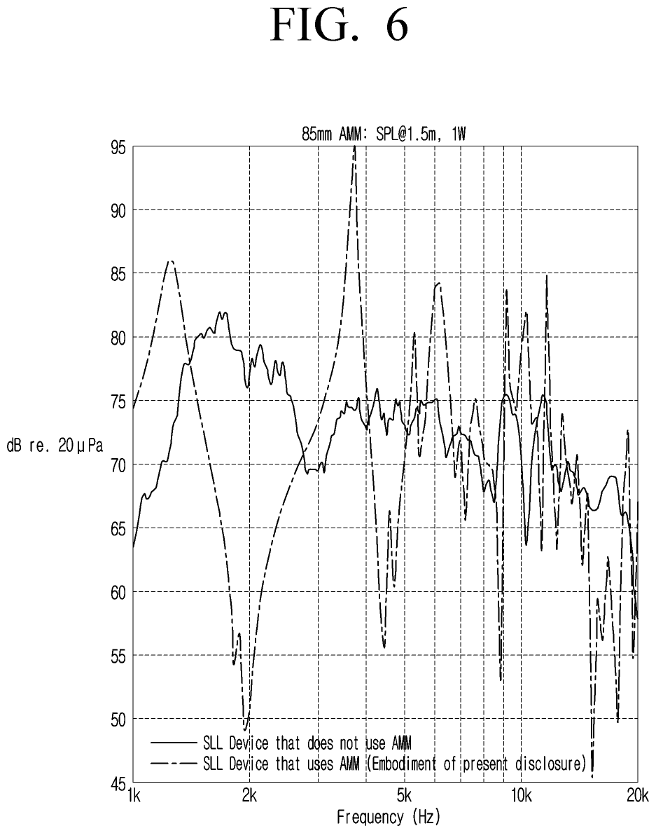

FIG. 6 is a graph for comparing sound waves of sound radiating outwardly from a speaker apparatus according to the prior art and embodiments of the present disclosure.

Specifically, the graph illustrated in FIG. 6 compares the results of measuring the frequency of sound waves radiated from a speaker apparatus (hereinafter, referred to as “first speaker apparatus”) that does not include the acoustic structure 30 and the auxiliary sound-absorbing material 50 and a speaker apparatus (hereinafter, referred to as “second speaker apparatus”) that includes the acoustic structure 30 and the auxiliary sound absorbing material 50 in which the resonant passages 31 are formed at a horizontal distance of 1.5 m from each apparatus.

The unit of the vertical axis is decibel, which indicates the measured sound pressure level, and the unit of the horizontal axis is hertz (Hz), which indicates the frequency of sound waves.

The first speaker apparatus not including the acoustic structure 30 and the auxiliary sound absorbing material 50 and the second speaker apparatus including the acoustic structure 30 and the auxiliary sound absorbing material 50 may include the same transducer 20. In other words, the sound waves generated from the first and second speakers are sound waves having the same frequency characteristics, but there may be a difference in the sound volume ultimately radiated to the outside of the speaker apparatus 1 from the first and second speakers due to a difference in the configuration of the first and second speakers.

As shown in FIG. 6, the sound waves ultimately radiated from the first speaker may have different volumes for each frequency range. For example, in a sound range having a frequency of 2 kHz, the volume may have a value corresponding to 50 dB, but in a sound range having a frequency of about 4 kHz, the volume may have a value corresponding to 95 dB.

As such, As can be seen through the shape of the one-point dashed line in FIG. 6, the shape of the amplitude spectrum of the sound wave may have a peak & dip pattern due to constructive and destructive interference of sound waves that may occur inside the speaker apparatus 1, which may deteriorate the sound quality of the sound radiated from the speaker apparatus 1.

On the other hand, the peak & dip pattern of the amplitude spectrum of the sound wave ultimately radiated from the second speaker may be smoother compared to the first speaker. This is the result of the sound waves of a specific frequency generated from the transducer 20 being absorbed by the auxiliary sound absorbing material 50 and/or the acoustic structure 30, as described in FIGS. 2 to 5.

As such, the amplitude spectrum of the sound waves radiated from the second speaker may be formed relatively evenly, so the second speaker may radiate higher quality sound compared to the first speaker.

FIG. 7 is an exploded view of a speaker apparatus according to another embodiment. Referring to FIG. 7, the buffer section 40 of the speaker apparatus 1 may be rectangular. Accordingly, each of the openings 311 of the plurality of resonant passages 31 surrounding the buffer section 40 may be aligned in a single line with respect to the three axes L1, L2, and L3.

The number of resonant passages 31 having the bending portion 312 may be less than the number of resonant passages 31 not having the bending portion 312. In other words, in the speaker apparatus 1 according to an embodiment based on the drawing of the present disclosure, the number of resonant passages 31 having the bending portion 312 may be less than in the embodiment illustrated in FIG. 4.

Further, in the embodiment of the present disclosure, the bending portion 312 of the resonant passages 31 may be formed to have only a right angle. Accordingly, the volume of the portion of the acoustic structure 30 excluding the resonant passages 31 can be minimized.

Compared to the speaker apparatus 1 according to the embodiment illustrated in FIG. 4, there is an effect that the lowest frequency among the frequency components of the sound waves absorbed by the resonant passages 31 according to the embodiment illustrated in the drawing of the present disclosure is raised.

Thus, the speaker apparatus 1 according to the embodiment illustrated in FIG. 7 may be manufactured to have a smaller size compared to the speaker apparatus 1 according to the embodiment illustrated in FIG. 4.

The speaker apparatus 1 according to the embodiment illustrated in FIG. 7 may be included in an electronic device designed to have a small size.

Further, the speaker apparatus 1 according to an embodiment has a relatively small volume of the acoustic structure 30 arranged in the accommodating space S, so the cost consumed for manufacturing the speaker apparatus 1 can be reduced.

Meanwhile, the buffer section 40 may be rectangular. Accordingly, a greater number of resonant passages 31 may be arranged along three sides of the rectangular buffer section 40 than when a plurality of resonant passages 31 are arranged along the circumference of the transducer 20. Any description of the buffer section 40 that is redundant to that described in FIG. 3 will be omitted.

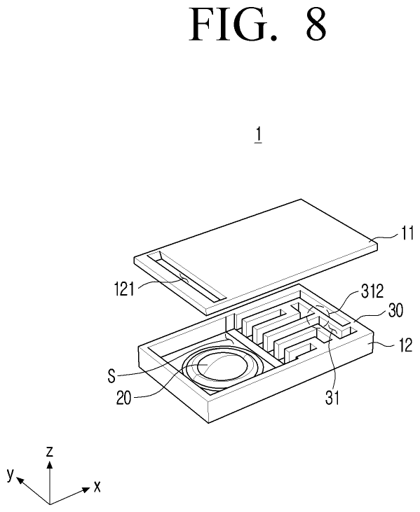

FIG. 8 is an exploded view of a speaker apparatus according to yet another embodiment. Referring to FIG. 8, the resonant passages 31 may be formed only in the area facing one side of the transducer 20. In other words, the resonant passages 31 may be arranged only in the area corresponding to one side excluding two sides of the three sides surrounding the transducer 20.

Specifically, the acoustic structure 30 may be provided between the first housing 11 and the area opposite to the area where the slot 121 of the second housing 12 is arranged. Thus, the speaker apparatus 1 according to an embodiment may have a smaller size compared to the speaker apparatus 1 disclosed in FIG. 7.

In order to minimize the volume of the acoustic structure 30 arranged within the accommodating space S, the bending portion 312 of the resonant passages 31 may be formed to have a right angle, and the number of bending portion 312 may be formed to be two or fewer. However, the shape and number of the bending portion 312 are not limited thereto, and the speaker apparatus 1 may be modified to have various shapes and numbers of bending portions during the design and manufacturing process.

Meanwhile, the transducer 20 of the speaker apparatus 1 according to an embodiment may be the transducer 20 that generates sound waves in a low frequency band. For example, the transducer 20 may be a woofer or a mid-range speaker.

A woofer generally refers to a speaker that produces frequencies between 20 Hz and 200 Hz. A mid-range speaker generally refers to a speaker that produces frequencies between 200 Hz and 2000 Hz. However, the frequencies produced by a woofer and a mid-range speaker included in the present disclosure are not limited to thereto.

The speaker apparatus 1 according to an embodiment may be included and used in an electronic device of a smaller size than the electronic device in which the speaker apparatus 1 illustrated in FIG. 7 is used.

Meanwhile, the speaker apparatus 1 according to FIGS. 7 and 8 may also include the auxiliary sound absorbing material 50 (see FIG. 5). In this case, the position where the auxiliary sound absorbing material 50 is arranged may be based on the same principle as described in FIG. 5, so the redundant description will be omitted.

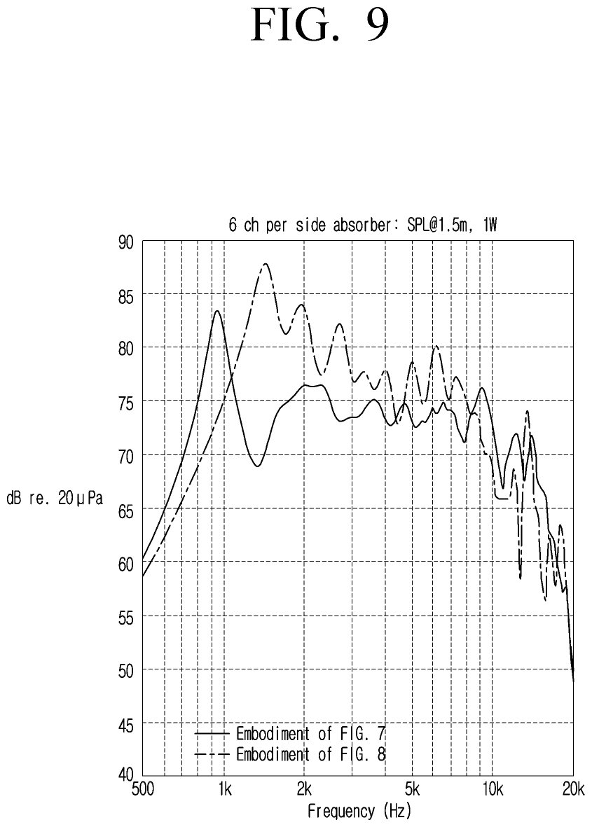

FIG. 9 is a graph for comparing sound waves of sound radiating outwardly from a speaker apparatus according to FIGS. 7 and 8.

The horizontal axis of the graph illustrated in FIG. 9 refers to hertz (Hz), which is the frequency of sound waves, and the vertical axis refers to decibel (dB), which is the measured sound pressure level. The solid line represents the sound volume for each frequency range of sound waves radiated from the speaker apparatus 1 according to the embodiment illustrated in FIG. 7, and the dotted line represents the sound volume for each frequency range of sound waves radiated from the speaker apparatus 1 according to the embodiment illustrated in FIG. 8.

As shown in FIG. 9, in the case of the speaker apparatus 1 according to the embodiment illustrated in FIG. 8, it can be seen that the decibel of the sound waves included in the frequency band exceeding 1 kHz and less than 8 kHz has a larger value overall compared to the speaker apparatus 1 according to the embodiment of FIG. 7. Meanwhile, in the case of the frequency exceeding 8 kHz, it can be seen that the sound waves generated from the speaker apparatus 1 according to the embodiment of FIG. 8 has a smaller decibel value compared to the speaker apparatus 1 according to the embodiment of FIG. 7.

As such, the speaker apparatus 1 according to the embodiment illustrated in FIG. 8 has the advantage that the size of the speaker apparatus 1 can be formed in a smaller size, although the effect of improving the acoustic characteristics may be limited to a narrow frequency band compared to other embodiments (such as the embodiment according to FIG. 7).

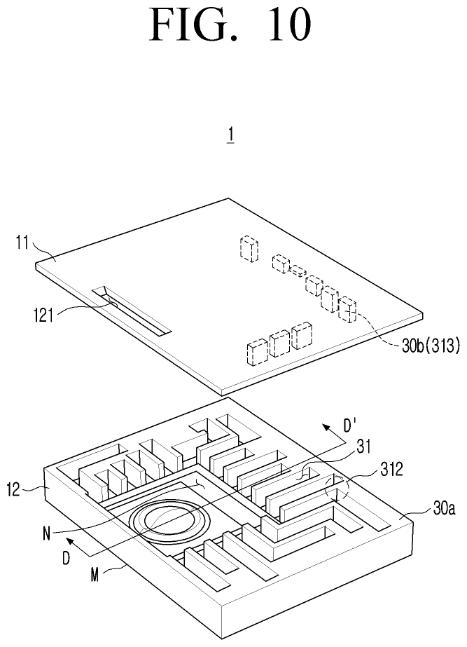

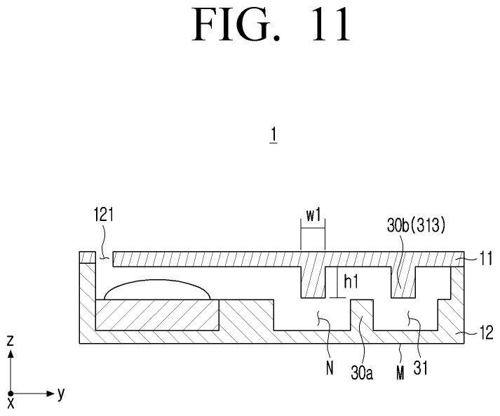

FIG. 10 is an exploded view of a speaker apparatus having a resonant passage of a double-layer structure. FIG. 11 is a view illustrating a cross-section along line D-D′ of FIG. 10. Referring to FIGS. 10 and 11, the first housing 11 may include an accommodating portion N formed by being inwardly recessed toward the lower surface M of the first housing from the second housing 12.

The acoustic structure 30 may include a first acoustic structure 30a arranged in the accommodating portion N and a second acoustic structure 30b coupled to an inner surface of the second housing 12.

The first acoustic structure 30a may include the resonant passages 31 formed by being etched from the second housing 12 to the lower surface M of the first housing. The resonant passages 31 may be formed to be surrounded by the first acoustic structure 30a and the second acoustic structure 30b.

The second acoustic structure 30b may include protrusions 313 that protrude toward the second housing 12.

The protrusions 313 may be arranged on the upper portion of the resonant passages 31. The protrusions 313 may be formed in an area opposite to the area where the slot 121 is positioned in the second housing 12.

The height (h1) of the protrusions 313 may be the same as the height (h2) of the first acoustic structure 30a, and the width (w1) of the protrusions 313 may be the same as the width (w2) of the resonant passages 31 formed in the first acoustic structure 30a, but the height (h1) and width (w1) of the protrusions 313 are not necessarily limited thereto.

The first acoustic structure 30a and the second acoustic structure 30b may be formed of the same material. The first and second acoustic structures 30a, 30b may be AMM structures.

Since the first housing 11 and the second housing 12 have corresponding shapes and are combined with their respective inner surfaces facing each other, the sound wave travel path in the Z direction of the first acoustic structure 30a and the second acoustic structure 30b may be longer than in the other embodiments described above.

In other words, since the resonant passages 31 of the speaker apparatus 1 according to an embodiment may be designed to have a longer length compared to the length of the accommodating space S compared to other embodiments, sound waves of a specific frequency that require a long resonant passages 31 may be effectively controlled.

That is, there is an advantage in that the speaker apparatus 1 smaller in size than the speaker apparatus 1 according to the embodiment of FIG. 4 can be implemented while forming the resonant passages 31 having the same length as the resonant passages 31 included in the embodiment of FIG. 4.

The number of resonant passages 31 having the bending portion 312 may be less than the number of resonant passages 31 not having the bending portion 312. The bending portion 312 may be a right angle, but the number of bending portion 312 and the angles at which the resonant passages 31 having the bending portion 312 are bent are not limited to those as shown in the drawing.

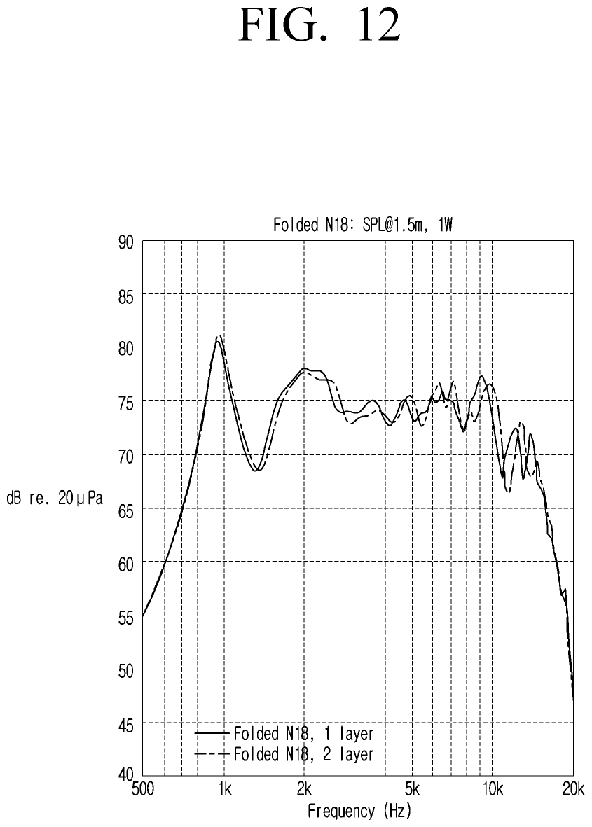

FIG. 12 is a graph provided to explain sound waves of sound radiating outwardly from a speaker apparatus according to FIG. 10.

The horizontal axis of the graph illustrated in FIG. 12 refers to the frequency of the sound waves in Hz, and the vertical axis refers to the sound pressure level in decibels (dB). The solid line is the sound radiated from the speaker apparatus 1 according to the embodiment shown in FIG. 4, and the dashed line is the sound radiated from the speaker apparatus 1 according to the embodiment shown in FIG. 10. FIG. 12 is a graph that records the sound volume at each frequency measured 1.5 meters away from the speaker apparatuses 1 for the sound emitted from these speaker apparatuses 1.

Referring to FIG. 12, the amplitude spectrum of the sound generated from the speaker apparatus 1 according to the embodiment of FIG. 10 can be compared to the amplitude spectrum of the sound generated from the speaker apparatus 1 according to the embodiment of FIG. 4.

In other words, it can be seen that the speaker apparatus 1 according to the embodiment of FIG. 10 has a smaller size than the speaker apparatus 1 according to the embodiment of FIG. 4, but the effect of controlling sound waves is similar.

As described in FIG. 10, in the speaker apparatus 1 according to various embodiments, sound waves radiated from the transducer 20 and propagating toward the internal accommodating space S of the speaker apparatus 1 may enter the resonant passages 31 through the openings 311 to form standing waves or resonate the resonant passages 31 so that the peak & dip pattern in the amplitude spectrum of the sound waves radiated from the speaker apparatus 1 can be controlled to appear relatively smooth.

Accordingly, it is possible to prevent the phenomenon where sound waves generated by the transducer (20) and directly emitted to the outside of the speaker apparatus 1 through the slot 121 without propagating toward the accommodating space S) interfere destructively and/or constructively with other sound waves. This improves the sound quality of the speaker apparatus 1.

While various embodiments of the present disclosure have been described above, each embodiment is not necessarily implemented in isolation, and the configuration and operation of each embodiment may be implemented in combination with at least one other embodiment.

Although preferred embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. A speaker apparatus comprising:
a housing;
a transducer inside the housing and configured to generate sound waves; and
an acoustic structure inside the housing and including a plurality of resonant passages, each resonant passage of the plurality of resonant passages having an opening facing toward the transducer so that the sound waves enter the opening and travel along the resonant passage.

2. The speaker apparatus of claim 1, wherein
the housing includes:
a first housing including an accommodating space in which the transducer and the acoustic structure are accommodated, and
a second housing covering one side of the first housing and including a slot facing the transducer to connect the accommodating space to outside of the housing.

3. The speaker apparatus of claim 1, wherein at least one resonant passage of the plurality of resonant passages includes a bent portion.

4. The speaker apparatus of claim 2, wherein
the first housing includes:
an accommodating portion in the accommodating space and that is recessed from the one side toward a lower surface of the first housing, and
the acoustic structure includes:
a first acoustic structure in the accommodating portion, and
a second acoustic structure coupled to an inner surface of the second housing and in the accommodating portion.

5. The speaker apparatus of claim 4, wherein the second acoustic structure includes a protrusion that protrudes from the inner surface of the second housing toward the first housing.

6. The speaker apparatus of claim 1, further comprising:
a buffer section between the transducer and the opening of each resonant passage of the plurality of resonant passages.

7. The speaker apparatus of claim 6, further comprising:
an auxiliary sound absorbing material in the buffer section.

8. The speaker apparatus of claim 6, wherein the buffer section includes a portion having a semicircular shape or a rectangular shape.

9. The speaker apparatus of claim 1, wherein the acoustic structure is an acoustic meta-material (AMM).

10. The speaker apparatus of claim 1, wherein
the housing includes:
a first housing, and
a second housing coupled to the first housing,
the transducer is on an inner surface of the first housing, and
each resonant passage of the plurality of resonant passages extends along the inner surface of the first housing in a direction away from the transducer and includes a meander shape having a plurality of bent portions.
